(19) United States
(12) Patent Application Publication
(10) Pub. No.: US 2014/0096206 A1
(43) Pub. Date: Apr. 3, 2014

(54) NETWORK ACCESS CONTROL SYSTEM AND METHOD

(71) Applicant: Grant David Kaufmann, London (GB)

(72) Inventor: Grant David Kaufmann, London (GB)

(73) Assignee: WHATEVER SOFTWARE CONTRACTS LIMITED, London (GB)

(21) Appl. No.: 14/118,065

(22) PCT Filed: May 15, 2012
(86) PCT No.: PCT/GB2012/051074

§ 371 Date: Nov. 15, 2013

(30) Foreign Application Priority Data
May 16, 2011 (GB) 1108068.6

(51) Int. Cl. H04L 29/06

(52) U.S. Cl. CPC H04L 63/10
USPC 726/4

(57) ABSTRACT

A system comprising a client that can place a network site access request to a network access server. In use, prior to placing the request, the client accesses the network access server to set up a network access profile relating to personal choices and accesses a trusted site to select options to provide a trusted site profile. When the client places a request, client data is provided along with the request whereby the client is automatically recognized by the server. Upon recognition, the server passes the client data to the trusted site, the trusted site uses the client data to retrieve the client's trusted site profile, which is then transferred to the server. A combining engine in the server then combines the trusted site profile with the network access profile and a filtering engine applies the combined profiles to permit or forbid the network site request to be fulfilled.

### FIELD OF THE INVENTION

The present invention relates to network communication and access security. It particularly relates to preventing access to undesirable material and data.

### THE PRIOR ART

Problems with unwanted and malicious material on the Internet and in communications networks in general are not new. Emails and website traffic are known to carry Spam (unwanted communications offering dubious products, services or social possibilities) as perhaps the lowest level problem. Phishing communications, where a thief seeks bank details to be unwittingly supplied by message respondents are also not the most malicious things that happen. Email attachments and elements of Internet site content can carry automatically installing so-called “malware” which can range from “spy ware”, which keeps track of computer activity and reports back to a sender such things as bank details and password keystrokes, to full computer crippling viruses which can disable all anti-viral protection and damage and destroy programs and files. Perhaps even worse, insidiously introduced malware can “robotize” a recipient computer to do the bidding of a remote master computer and send, on the master's behalf, spam emails and further robotizing attacks to email addresses found in victim computer email address books. The present invention seeks to make a computer more protected from receiving malware.

On board processor precautions abound against malware. Numerous applications are available, to be installed in a computer, offering antiviral, anti-spy ware and firewall facilities. Though such precautions are generally effective, effectiveness is not always maintained. For example, one has only to run an anti-spy ware application to discover that numerous infections can exist without apparent impairment to operation of the computer. When some malware is opened, the existing anti-malware precautions are automatically disabled, making a mockery of the attempted safekeeping of the now infected processor. The present inventing seeks to improve upon malware protection and to prevent or make less likely initial malware infection.

Certain websites carry a risk to any visitor. Malware is downloaded without the operator's knowledge or consent by criminal and state enterprises. Such downloading is also a feature of so called cyber attacks. The present invention seeks to make less likely a visit to a risky website.

Precautions can rapidly fall out of date. An infection to a processor can occur within hours of its first appearing in the World, and before most processors have had a chance to update their precautions. The present invention seeks to make it possible that updated precautions are automatically available and applied within the shortest possible lapse of time.

### SUMMARY OF INVENTION

According to a first aspect, the present invention consists in a system comprising: a client, operable to a make network access request to access a resource in a network; the client being operable to access a network access server in the network to set up a network access profile; the client being operable to access at least one trusted network site in the network to set up at least one trusted site profile; the client being operable to pass the network access request to the network access server; the network access server comprising a combining engine operable, upon receipt of the network access request, to combine the network access profile with the at least one trusted site profile to form a combined profile; and the network access server also comprising a filtering engine operable to test the network access request and to allow access to the resource only if the combined profile is not violated.

According to a second aspect, the present invention consists in a method of accessing a network resource comprising; a step of accessing a network access server in the network and establishing a network access profile; a step of accessing at least one trusted site in the network and establishing at least one trusted site profile; a step of issuing a network access request to the network access server; a step of the network access controller combining the network access profile and the at least one trusted site profile; and a step of the network access server allowing the network resource access request if and only if the combined profile is not violated.

The invention further provides that the at least one trusted site profile can be updatable at the at least one trusted site; and that the at least one trusted site profile is transferable from the at least one trusted site to the network access server in response to receipt of a network access request.

The invention further provides that the network access request can include client data enabling identification of the client by the network access server.

The invention further provides that the network access server can pass the client data to the at least one trusted site, that the at least one trusted site can employ the client data to retrieve the associated trusted site profile, and that the at least one trusted site can pass the associated trusted site profile to the network access server.

The invention also provides that the at least one trusted site profile can include at least one of: the identity of network addresses; IP ports; content; time of day it is permitted to access; and the identity of network addresses; IP ports; content; and time of day it is forbidden to access.

### BRIEF DESCRIPTION OF THE DRAWINGS

The invention is further described and explained, by way of example, by the following description, to be read in conjunction with the appended drawings, in which

FIG. 1 shows a schematic diagram illustrating a first phase of operation of a system of elements through which the invention is implemented.

FIG. 2 shows showing a second phase of operation of the system of elements through which the invention is implemented

FIG. 3 shows a schematic block diagram of exemplary elements of one possible implementation of the network access server of FIGS. 1 and 2.

FIG. 4 shows an exemplary flow chart illustrating one of many possible manners in which the client can set up the client server option prior to use of the network access server to communicate with the network.

FIG. 5 is an exemplary flow chart illustrating one possible way in which a client 10 can select trusted client options supplied by the trusted site 16. and

FIG. 6 is a flow chart illustrating one possible way in which a client can access the network access server and the trusted site

### DETAILED DESCRIPTION OF THE INVENTION

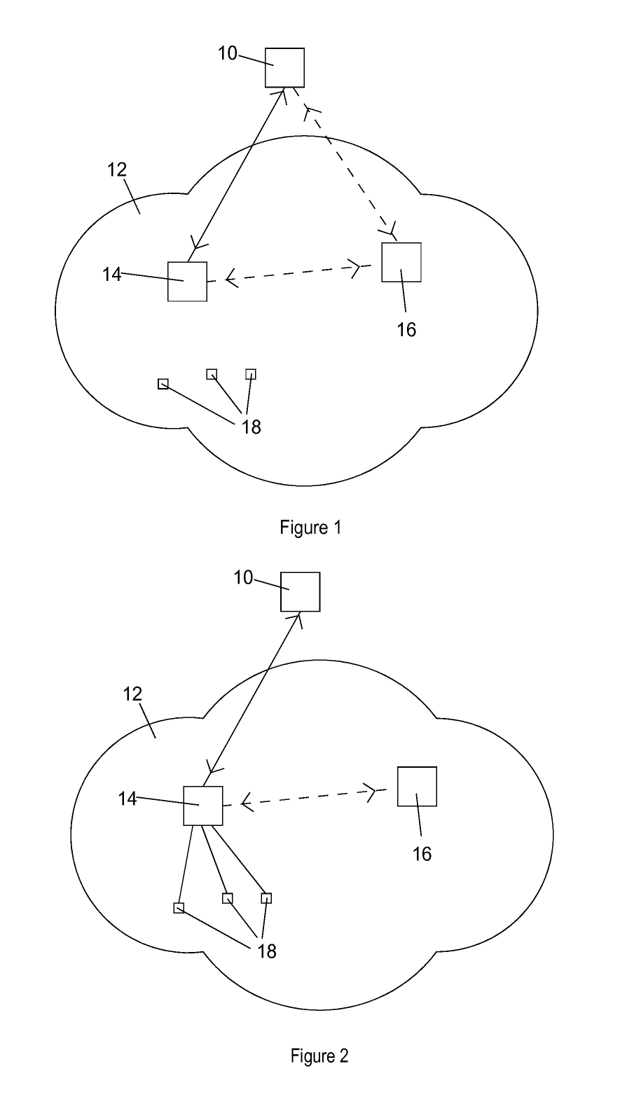

Attention is first drawn to FIG. 1, a schematic diagram illustrating a first phase of operation of a system of elements through which the invention is implemented, and to FIG. 2, showing a second phase of operation.

A client processor 10, such as a Personal Computer (PC), is network enabled and can operate with sites and services provided in a network 12 such as, but not limited to, the Internet. The client 10 can also be a portable device capable of internet access by WiFi® or mobile telephone systems.

Within the network 12 is a network access server 14. The client 10 can access the network access server by addressing the IP address of the network access server 14.

Also within the network 12 is a trusted site 16 containing selectable and configurable profiles for controlling the network access capability of the client 10 when the client, as will be explained, employs the network access server 14 to access other desirable sites 18.

Two phases of operation are involved.

The first phase is setup, where the client 10 accesses first the network access server 14 to set up client server options, and the client 10 also access the trusted site 16 to set up client trusted site options. As illustrated in FIG. 1, the trusted site 16 and the network access sever 14 can communicate with each other to indicate to the network access server 14 which trusted site 16 is to be accessed and vice versa.

The second phase is operation, as illustrated by FIG. 2, where the client 10 accesses the network access server 14 to access the desired sites 18 through the network access server 14 using the combination of the client server options and the client trusted site options. During the second phase of operation, the trusted site 16 and the network access server 14 communicate to convey the client trusted site option to the network access server 14 for use therein

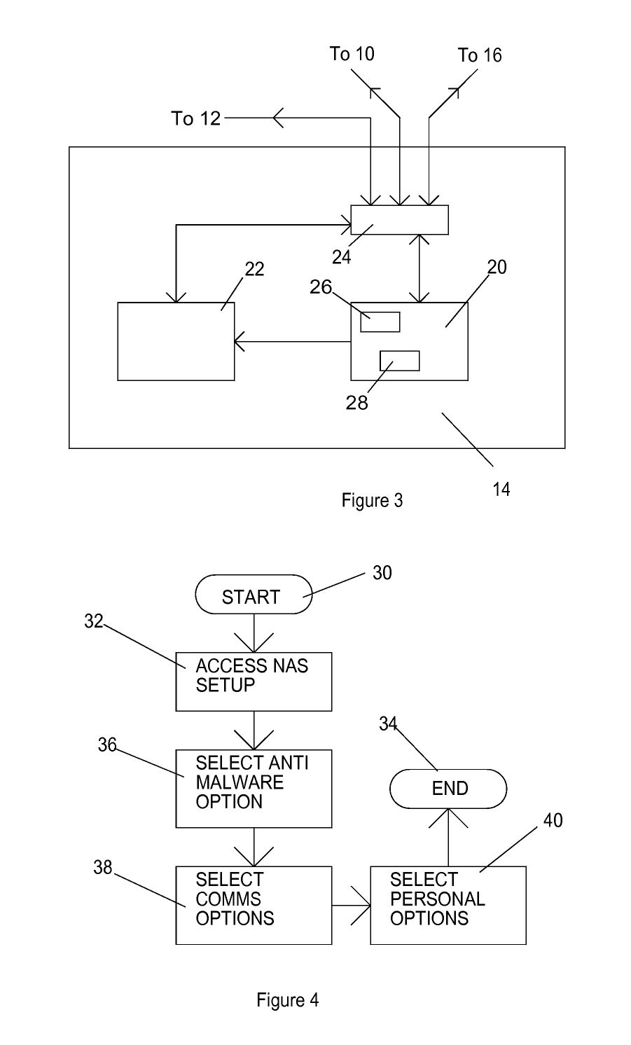

Attention is next drawn to FIG. 3, a schematic block diagram of exemplary elements of one possible implementation of the network access server 14 of FIGS. 1 and 2.

The network access server 14 comprises a combining engine 20 and a filtering engine. The network access server 14 also comprises digital communication means 24 which can include, but is not restricted to, a modem operable to send and receive data and requests through the network 12 to access the client 10, the trusted site 16, and any other site in the network 12 which the client 10 may wish to contact. Although FIG. 3 shows only one communication means 24, it is to be understood that two or more communication means 24 may be employed to provide the function of the network access server and here before and here after described and claimed. Communication means can also include a network connection

The network access server also comprises at least two memories, a client memory 26 and a trusted site memory 28. The client memory 26 stores client identification, together with the client server options set up by the client 10. The trusted site memory stores the trusted site details, including the trusted site 16 identity and the trusted site setup details, which will be expanded upon hereafter.

Attention is next drawn to FIG. 4 which shows an exemplary flow chart illustrating one of many possible manners in which the client 10 can set up the client server option prior to use of the network access server 14 to communicate with the network 12.

From a start 30 a first operation 32 has the client 10 access the setup interface of the network access server (NAS) 14 and verify their identity by, for example, client 10 IP address or any automatic machine identity label, such as a Mac number, which may be available, the automatic identifiers being useable either singly or collectively. The client 10 can also be asked to provide a password and other personal information. If the first operation finds that the client 10 is unknown to the network access server 14, the client can be required to set up an account and to provide suitable individual password information. Of course, if the client 10 declines to setup an account, the first operation 32 can proceed directly to exit 34, thereby allowing the client 10 to try again if the rejection was due to some fault of information.

If the first operation 32 is successful, a second operation 36 then selects the anti malware option desired by the client 10. Use of an anti malware option, resident in the network access server 14, gives the advantage to the client 10 that the anti malware option is always up to date and only derived from a reliable source. The user of the client 10 selects which of one or more anti malware resident programs the user wishes to employ. Malware can range from spy ware, viruses, robotizing programs and obnoxious cookies, to name but a few. The user of the client 10 can also elect to override the malware option and to employ no malware option in the network access server 14 but rather to use anti malware options installed within the client 10 itself.

A third operation 38 then selects any communications option that the user of the client 10 may elect to avoid. For example, WiFi communication can be subject to eavesdropping as can be telephone networks. As an example, the user of the client 10 may elect to be limited to hardwired communication. Certain protocols can contain malicious content, for example, certain types of images. The user of the client 10 may elect to avoid particular file types and protocols.

The third operation 38 complete, a fourth operation 40 then has the user of the client 10 select any personal options, such as, for example, any email addresses the user does not care to commutate with, any websites the user wishes to avoid, any type of email the user wishes not to receive, and so on. Personal options can be many and varied.

When the fourth operation 40 is complete, the client server option setup is complete. The process leaves by exit 34. The client server options are stored in the client memory 26 ready to be used when the client 10 attempts network access. The client server options can be updated at any time. Updating can be elected by the user of the client 10. One option is to have account setup and updating possible only under administrator control so that a client, typically in an organization, can be set up so that individual users cannot change the settings and a uniformity of settings can be achieved across an organization.

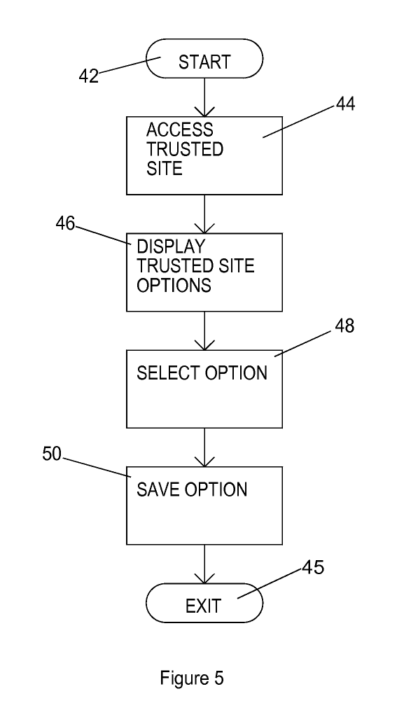

Attention is next drawn to FIG. 5, an exemplary flow chart illustrating one possible way in which a client 10 can select trusted client options supplied by the trusted site 16.

From start 42 a fifth operation 44 has the client 10 access the trusted site 16 setup page. As with the client server option setup, as described above, the client 10 can be required to verify their identity by, for example, client 10 IP address or any automatic machine identity label, such as a Mac number, which may be available, the automatic identifiers being useable either singly or collectively. The client 10 can also be asked to provide a password and other personal information. If the fifth operation 44 finds that the client 10 is unknown to the trusted site 16, the client 10 can be required to set up an account and to provide suitable individual password information. Of course, if the client 10 declines to setup an account, the fifth operation can proceed directly to exit 45, thereby allowing the client 10 to try again if the rejection was due to some fault of information. Access to the trusted site may be restricted to a set of trusted organizations that may be required to verify their identity.

A sixth operation then has the trusted site 16 display the trusted site options available.

These may be, for example, sites which, in the view of a particular organization, are acceptable for client access, and may include many options depending upon the function of the particular client 10 machine. If, for example, the client 10 is to be used for a warehouse operation, only network 12 sites apt for viewing from a warehouse operation would be permitted. Other options can, but are not limited to, include accountancy appropriate sites, engineering appropriate sites, and so on.

The trusted site options can also include, but are not limited to, exclusion of risky sites, where malware or other problems have been encountered.

The trusted site options can also include, but are not limited to, exclusion of timewaster sites, access to which can provide social, gaming or entertainment activity to the detriment of employment related use.

The trusted site options can also include exclusion of access to sites which are considered morally, politically or religiously unsuitable. This exclusion is apt for regulating Internet activity of young persons and school pupils.

The trusted site options can involve a so-called “White List” of all those sites to which access is allowed. Alternatively, the trusted site options can include a listing of sites to which no access is allowed. As a second alternative, the trusted site options can include a combination of sites to which access is allowed together with sites to which access is denied. This last feature has the technical advantage of preventing access by link clicking from a permitted site to a non permitted site.

The sixth operation 46 is followed by a seventh operation 48 where the client 10 selects from among the trusted site options displayed in the fifth operation 46. The client 10 can select just one trusted site option, or can select two or more selected site options which can be applied together.

An eighth operation 50 then stores the selected trusted site option or options for later selection and application by identification of the particular client 10 and calling up of the stored option or options. The process then exits by way of exit 45.

The trusted site options can be updated at any time. Updating can be elected by the user of the client 10. One option is to have account setup and updating possible only under administrator control so that a client, typically in an organization, can be set up so that individual users cannot change the settings and a uniformity of settings can be achieved across an organization.

The particular content of a trusted site option can also be updated by a supplying organization. When logging on to the network access server 14, as will be later explained, this provides the technical advantage of always providing the most up to date version of the trusted site option or options to the selecting client 10.

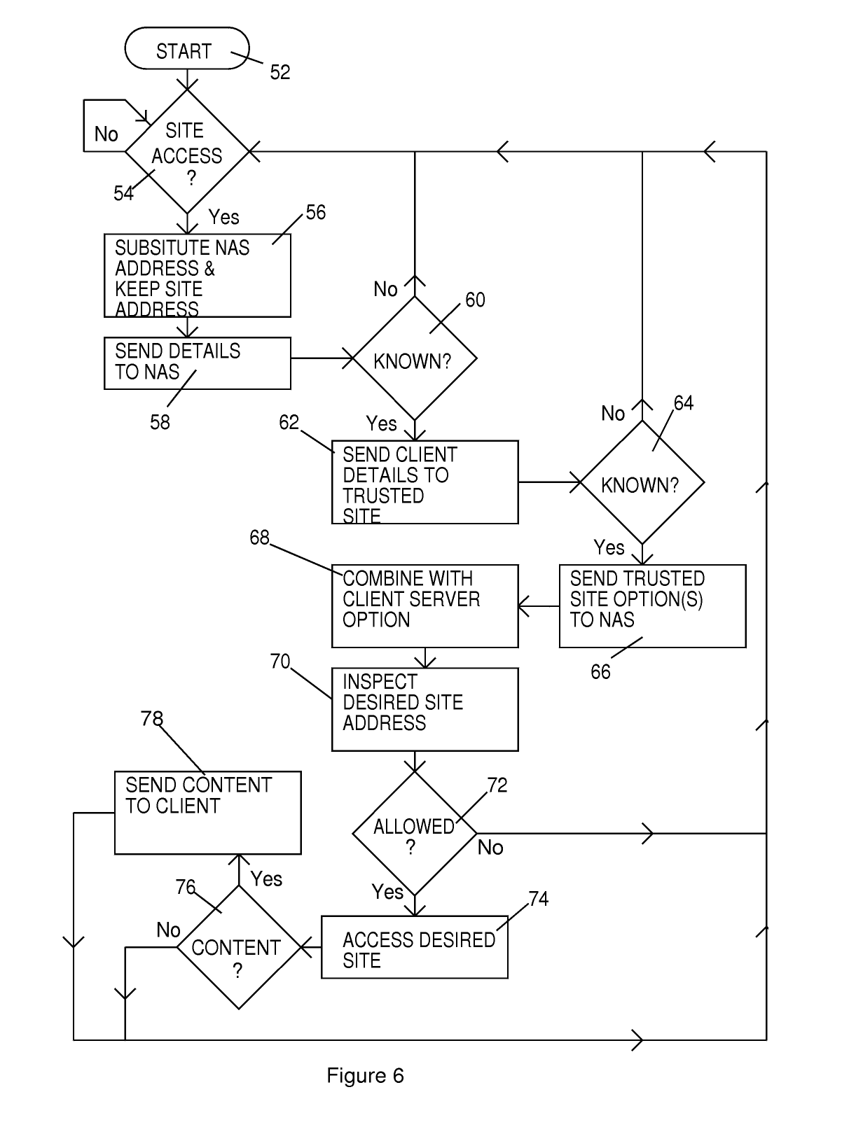

Attention is next drawn to FIG. 6, a flow chart illustrating one possible way in which a client 10 can access the network access server 14. FIG. 6 shows in part the activity of client 10, in part the activity of the network access server 14 and in part the activity of the trusted site 16.

From start 52, if a first test 54 detects that the client 10 seeks access to a desired website or internet service, in this example by means of use of a browser, and the client is equipped to utilize the present invention, a ninth operation 56 substitutes the web address of the network access server 14 in place of the desired address and retains and passes on the desired address and the client identifying details to a tenth operation 58 which contacts the network access controller and passes on the client details and desired web address to the network access server 14. The substitution of the web address of the network access server 14 can also be accomplished by any means that leads to the network access server acting as the passage through which contact with the network is controlled and established.

If a second test 60 in the network access server (NAS) 14 detects that the client details, received from the tenth operation 58 in the client 10, are not recognized, control is passed back to the first test 54 to wait for further network access requests. If a second test 60 in the network access server (NAS) 14 detects that the client details, received from the tenth operation 58 in the client 10, are recognized, an eleventh operation 62 passes the client details to the trusted site 16 where a third test 64 checks if the client details are recognized.

If the client details are not recognized by the third test 64 in the trusted site 16, control is passed back to the first test 54 again to await a client 10 network access request. If the client details are recognized by the third test 64 in the trusted site 16, control is passed to a twelfth operation 66 which uses the client details to identify the corresponding trusted site option and to pass the option data back to a thirteenth operation 68 in the network access server 14.

It is not always necessary to pass the identified trusted site option(s) data back to the thirteenth operation 68. If the trusted site option(s) have not changes since last access, the stored content of the trusted site memory 28 can be used, thus speeding up access.

The thirteenth operation 68 acts as a combining engine to combine the restrictions from the client memory 26 and the content of the trusted site memory 28 to impose the combined restrictions upon traffic to and from the client 10.

A fourteenth operation 70 in the network access server 14 checks the desired web address against the combined restrictions. If a fourth test 72 detects that any aspect of the desired web address is not allowed, control is passed to the first test 54 again to await a client 10 access request. If the fourth test 72 detects that the desired web address is allowed, a fifteenth operation 74 in the network access server 14 accesses the desired address from the network 12 and inspects its delivered data.

If a fifth test 76 in the network access server 14 finds that any aspect of the delivered data from the desired website is not acceptable according to the combined restrictions, control is passed to the first test 54 again to await a client 10 network 12 access request. If the fifth test 76 in the network access server 14 finds that acceptable according to the combined restrictions, a sixteenth operation 78 sends the desired web address data to the client 10 and the client 10 is also free to send, through the network access server 14, any data or mail it has to send.

Control is then passed back to the first test 54 again to await a client 10 network access request.

The fourteenth 70 to sixteenth 78 operations and the fourth 72 and fifth 72 tests together, in their combination, act as a filtering engine.

The invention has been here before described with reference to combining restrictions from only two sources. It is to be understood that the invention includes combination of restrictions from three or more separate sources.

The invention has been described by way of examples. Those, skilled in the art, will be aware that many different options of order of a activity execution, hardware organization and data and information transfer that can be employed without departing from the invention as clamed hereafter.

The invention is further clarified and defined by the appended claims.

1. A system comprising:
a client, operable to make network access requests to a resource in a network;
the client being operable to access a network access server in the network to set up a network access profile;
the client being operable to access at least one trusted network site in the network to set up at least one trusted site profile;
the client being operable to pass the network access request to the network access server;
the network access server comprising a combining engine operable, upon receipt of the network access request, to combine the network access profile with the at least one trusted site profile to form a combined profile; and
the network access server also comprising a filtering engine operable to test the network access request and to allow access to the resource only if the combined profile is not violated.

2. The system, according to claim 1,
wherein the trusted site profile is updatable at the trusted site; and
wherein the at least one trusted site profile is transferable from the at least one trusted site to the network access server in response to receipt of a network access request.

3. The system, according to claim 1, wherein the network access request includes client data enabling identification of the client by the network access server.

4. The system, according to claim 3, wherein the network access server is operable to pass the client data to the at least one trusted site, wherein the at least one trusted site is operable to employ the client data to retrieve the associated at least one trusted site profile, and wherein the at least one trusted site is operable to pass the associated at least one trusted site profile to the network access server.

5. The server, according to claim 1, wherein the at least one trusted site profile includes at least one of the identity of network resource identifiers it is permitted to access; the identity of IP ports it is permitted to access; type of content it is permitted to access; time of day it is permitted to access; the identity of network resource identifiers it is forbidden to access; IP ports it is forbidden to access; type of content it is forbidden to access; and time of day when it is forbidden to access.

6. A method of accessing a network resource comprising:
a step of accessing a network access controller in a network and establishing a network access profile;
a step of accessing at least one trusted site in the network and establishing at least one trusted site profile;
a step of issuing a network resource access request to the network access controller;
a step of the network access controller combining the network access profile and the at least one trusted site profile; and
a step of the network access controller allowing the network resource access request if and only if the combined profile is not violated.

7. The method, according to claim 6, further comprising:
a step of updating the at least one trusted site profile;
and
a step of transferring the at least one trusted site profile from the at least one trusted site to the network access server in response to receipt of the network access request.

8. The method, according to claim 6, further comprising:
a step of including client data in the network access request, and a step of identifying, in the network access server, a particular client from the client data.

9. The method, according to claim 8, further comprising:
a step of the network access server passing the client data to the at least one trusted site;
a step of the at least one trusted site employing the client data to retrieve the associated at least one trusted site profile; and
a step of the at least one trusted site passing the associated at least one trusted site profile to the network access server.

10. The method, according to claim 6, wherein the at least one trusted site profile includes at least one of: the identity of network resource identifiers it is permitted to access; the identity of IP ports it is permitted to access; type of content it is permitted to access; time of day it is permitted to access; the identity of network resource identifiers it is forbidden to access; IP ports it is forbidden to access; type of content it is forbidden to access; and time of day when it is forbidden to access.

11. (canceled)

12. (canceled)
